(19) United States
(12) Patent Application Publication
(10) Pub. No.: US 2012/0286573 A1
(43) Pub. Date: Nov. 15, 2012

(54) POWER MANAGING SYSTEM

(75) Inventor: Kazuma Sekiya, Ota-Ku (JP)

(73) Assignee: DISCO CORPORATION, Tokyo (JP)

(21) Appl. No.: 13/450,764

(22) Filed: Apr. 19, 2012

(30) Foreign Application Priority Data
May 11, 2011 (JP) 2011-106021

(51) Int. Cl. H02J 3/38

(52) U.S. Cl. 307/20

(57) ABSTRACT

A power managing system including a power plant and a plurality of electric vehicles each having a battery for storing the power generated by the power plant. The power stored in the battery of each electric vehicle is recovered to the power plant according to demand for power during the time when each electric vehicle is not in use.

### BACKGROUND OF THE INVENTION

1. Field of the Invention

The present invention relates to a power managing system which can attain effective use of power.

2. Description of the Related Art

A power company such as Tokyo Electric Power Company, Inc. generates power at various power plants such as a hydroelectric power plant, thermal power plant, nuclear power plant, wind power plant, and solar power plant. The power thus generated is consumed at government and municipal offices, local governments, hospitals, general companies, general homes, etc. The consumption of power changes according to time zone, season, etc. and the power company therefore puts various power generating methods into full use to supply power according to demand. The power once generated is difficult to store, so that it is necessary to manage the operation of the power plants according to changes in demand. In the summertime, an enormous amount of power is required to operate air conditioners, so that the operation of the power plants is adjusted and managed so as to make the maximum power supply accord with the maximum power demand in the summertime.

### SUMMARY OF THE INVENTION

However, the power generating method depending on weather, such as wind power generation and solar power generation, has a problem such that although weather is suitable for power generation and a large amount of power can be generated, there is a case that the power is not effectively used to become wasted, resulting in no economy. Further, the power company places various power plants so as to support the maximum demand for power to be consumed. However, in the event that some of the power plants such as nuclear power plants fail to operate due to a disaster such as an earthquake, power cannot be supplied according to demand. As a result, there unavoidably occur a thinned-out operation and service stop of trains and intentional power cut, for example, causing a reduction in productivity in companies, traffic trouble, etc. to result in the confusion of economy.

It is therefore an object of the present invention to provide a power managing system which can effectively store the generated power and recover the stored power according to demand.

In accordance with an aspect of the present invention, there is provided a power managing system including: a power plant; and a plurality of electric vehicles each having a battery for storing the power generated by the power plant; wherein the power stored in the battery of each electric vehicle is recovered to the power plant according to demand for power during the time when each electric vehicle is not in use.

The power managing system of the present invention has been achieved by expecting that the widespread use of electric vehicles will be increased in the future and focusing attention on the satisfactory charging function of electric vehicles. According to the present invention, the power stored in the battery of each electric vehicle is recovered to the power plant according to demand for power during the time when each electric vehicle is not in use. The power thus recovered is supplied to any place where power is demanded. Accordingly, the power generated by a power generating method depending on weather, such as wind power generation and solar power generation, can be stored in the battery of each electric vehicle, so that the power thus generated can be effectively used without being wasted.

Further, power may be generated in the night, for example, when power consumption is low, and this power may be stored in the battery of each electric vehicle. Further, the power may be recovered from the battery of each electric vehicle being not used in the daytime when power consumption is high, and this power recovered may be supplied to any place where power is demanded. Accordingly, even when the power supply capacity of the power plant becomes lower than the maximum demand for power to be consumed, the thinned-out operation and service stop of trains and intentional power cut, for example, can be avoided.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWING

FIG. 1 is a schematic diagram for illustrating the power managing system according to the present invention.

### DETAILED DESCRIPTION OF THE PREFERRED EMBODIMENT

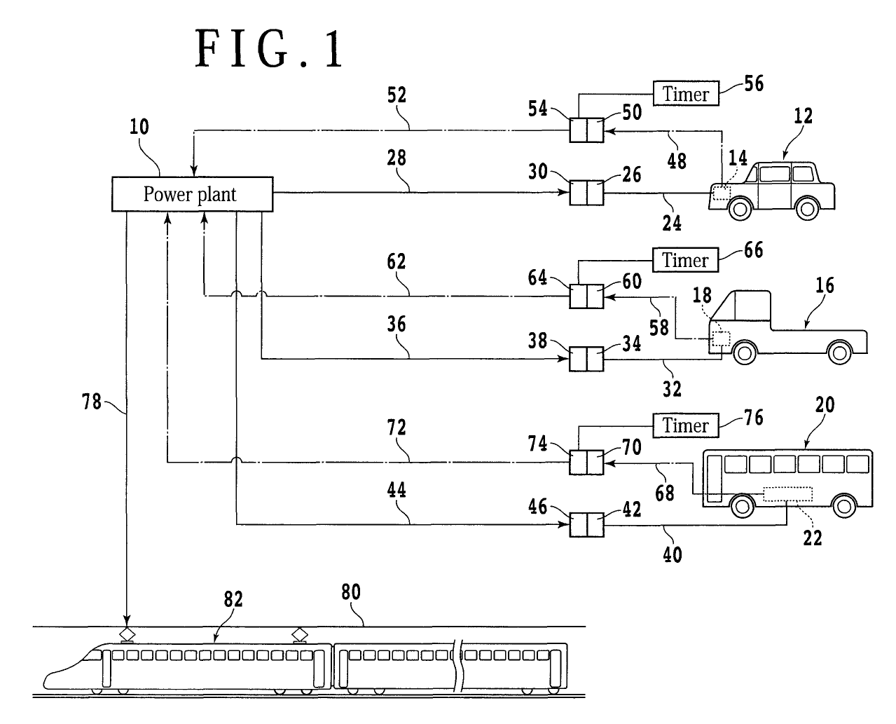

A preferred embodiment of the present invention will now be described in detail with reference to FIG. 1. The power managing system according to the present invention includes a power plant 10 and a plurality of electric vehicles each having a battery for storing the power generated by the power plant 10. The electric vehicles include a passenger car 12, a truck 16, and a bus 20. A battery 14 is mounted in the passenger car 12, a battery 18 is mounted in the truck 16, and a battery 22 is mounted in the bus 20. These batteries 14, 18, and 22 are lithium ion batteries.

The battery 14 of the passenger car 12 is charged by connecting a cable 24 to the battery 14 and connecting a connector 26 connected to the cable 24 to a connector 30 connected to a feeder cable 28. Similarly, the battery 18 of the truck 16 is charged by connecting a cable 32 to the battery 18 and connecting a connector 34 connected to the cable 32 to a connector 38 connected to a feeder cable 36. Similarly, the battery 22 of the bus 20 is charged by connecting a cable 40 to the battery 22 and connecting a connector 42 connected to the cable 40 to a connector 46 connected to a feeder cable 44. Charging of these batteries 14, 18, and 22 is preferably performed in the night when power consumption is low.

In the case that the power supply capacity of the power plant 10 may possibly become lower than the maximum demand for power to be consumed, the power stored in the batteries 14, 18, and 22 is recovered to the power plant 10 during the time when the electric vehicles including the passenger car 12, the truck 16, and the bus 20 are not in use. Then, this recovered power is supplied to any place where power is demanded.

The power stored in the battery 14 of the passenger car 12 can be recovered to the power plant 10 by connecting a recovery cable 48 to the battery 14 and connecting a connector 50 connected to the recovery cable 48 to a connector 54 connected to a recovery/transmission cable 52. In recovering the power from the battery 14, a timer 56 is connected to the connector 54 to measure the recovery time with the timer 56, whereby the owner of the passenger car 12 can bill the power company of the power plant 10 for the recovered power as a recovered power rate according to the recovery time measured above.

Similarly, the power stored in the battery 18 of the truck 16 can be recovered to the power plant 10 by connecting a recovery cable 58 to the battery 18 and connecting a connector 60 connected to the recovery cable 58 to a connector 64 connected to a recovery/transmission cable 62. In recovering the power from the battery 18, the recovery time is measured by using a timer 66 and the owner of the truck 16 can bill the power company of the power plant 10 for the recovered power as a recovered power rate according to the recovery time measured above.

Similarly, the power stored in the battery 22 of the bus 20 can be recovered to the power plant 10 by connecting a recovery cable 68 to the battery 22 and connecting a connector 70 connected to the recovery cable 68 to a connector 74 connected to a recovery/transmission cable 72. In recovering the power from the battery 22, the recovery time is measured by using a timer 76 and the owner of the bus 20 can bill the power company of the power plant 10 for the recovered power as a recovered power rate according to the recovery time measured above. The power recovered above is supplied through a transmission cable 78 to a power cable 80 for a train 82, thereby preventing a thinned-out operation, service stop, etc. of the train 82.

### Example 1

(1) In the case that the supply power rate is 20 yen/kWh, for example, the power company having the power plant buys the recovered power from the owner of the electric vehicle at 21 yen/kWh.

(2a) In the case that the owner of the electric vehicle is not driving the electric vehicle and sells the power stored in the battery, the owner specifies the remaining power (kWh or %) to be left in the battery.

(2b) In the case that the owner of the electric vehicle is not driving the electric vehicle and sells the power stored in the battery, the owner specifies the day of the week (e.g., Saturday or Sunday) and the time (e.g., 22:00 to 24:00) and also specifies the remaining power (kWh or %) to be left in the battery.

(3) The power company recovers the power from the battery of the electric vehicle according to demand and then supplies the recovered power to any place where power is demanded.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A power managing system comprising:
a power plant; and
a plurality of electric vehicles each having a battery for storing the power generated by said power plant;
wherein the power stored in said battery of each electric vehicle is recovered to said power plant according to demand for power during a time when each electric vehicle is not in use.
